(19) United States
(12) Patent Application Publication
(10) Pub. No.: US 2026/0167176 A1
(43) Pub. Date: Jun. 18, 2026

(54) VEHICLE CONTROL DEVICE AND METHOD FOR CONTROLLING VEHICLE DYNAMICS

(71) Applicants: HYUNDAI MOTOR COMPANY, Seoul (KR); KIA CORPORATION, Seoul (KR)

(72) Inventors: Seungtae Baek, Hwaseong-si (KR); Ryong Choe, Hwaseong-si (KR); Jooyoung Kang, Hwaseong-si (KR); Baekyu Kim, Hwaseong-si (KR); Yeongil Choi, Hwaseong-si (KR)

(73) Assignees: HYUNDAI MOTOR COMPANY, Seoul (KR); KIA CORPORATION, Seoul (KR)

(21) Appl. No.: 19/194,596

(22) Filed: Apr. 30, 2025

(30) Foreign Application Priority Data
Dec. 17, 2024 (KR) 10-2024-0188459

(51) Int. Cl. B60W 30/02; B60R 16/023

(52) U.S. Cl. CPC B60W 30/025; B60R 16/0231; B60W 2510/22; B60W 2520/06; B60W 2520/105; B60W 2520/125; B60W 2520/16; B60W 2520/18; B60W 2520/26

(57) ABSTRACT

The present disclosure relates to a vehicle attitude control device and method. The vehicle attitude control device may include a drive unit configured to independently transmit driving force to each of a plurality of wheels of a vehicle, and a control unit configured to recognize a situation of the vehicle, calculate a driving force (e.g., required) for the situation based on preset (e.g., required) vertical force information corresponding to the situation of the vehicle and vehicle information, and control the drive unit.

### CROSS-REFERENCE TO RELATED APPLICATION(S)

This present application claims the benefit of priority to Korean Patent Application No. 10-2024-0188459, filed on Dec. 17, 2024, in the Korean Intellectual Property Office, the entire disclosure of which is incorporated herein by reference.

### TECHNICAL FIELD

The present disclosure relates to a vehicle dynamics (e.g., attitude) control device and method, and more specifically, to a vehicle control device and method for controlling the dynamics (e.g., attitude) of a vehicle by independently driving each wheel of the vehicle.

### BACKGROUND

Various technologies have been developed to improve driving stability and ride comfort of vehicles. Recently, technologies for controlling vehicle attitude have gained attention, and these technologies aim to suppress attitude changes such as pitch, roll, and heave that occur during driving. In particular, suspension and drive control systems are being used for (e.g., simultaneously) improving ride comfort and handling performance in high-performance vehicles and luxury sedans.

Among existing technologies, active suspension is a representative technology. Active suspension provides damping force and vehicle height appropriate for driving conditions by adjusting the vehicle's suspension in real time through electronic control. Such technology may improve the ride comfort and handling performance of a vehicle by suppressing rolling during driving and maintaining body stability in irregular road environments. It is mainly applied to high-performance vehicles such as sports cars and luxury sedans, providing a more comfortable driving experience to drivers and passengers.

However, because active suspension technology is based on complex electronic control devices and hydraulic systems, the active suspension technology has high manufacturing costs. For this reason, active suspension is mainly applied to expensive, high-performance vehicles rather than mass-market vehicles, and its use in general vehicles is limited.

### SUMMARY

The present disclosure is directed to providing a vehicle attitude control device and method that (e.g., precisely) control the attitude (e.g., dynamics) of a vehicle, such as pitch, roll, and heave, by independently providing driving force to each wheel, thereby (e.g., simultaneously) improving stability and ride comfort even in states (e.g., situations) of rapid corners, acceleration, and braking.

The present disclosure is further directed to providing a vehicle attitude control device and method capable of suppressing vehicle body movement through dynamic attitude control and enhancing ride comfort, and implementing (e.g., necessary) motions using static attitude control, thereby providing various business applications and new vehicle contents.

The present disclosure is further directed to providing a vehicle attitude control device and method that, when combined with an in-wheel motor (IWM) system, are capable of mitigating ride comfort degradation and driving performance issues associated with in-wheel motors.

The present disclosure is further directed to providing an economical and efficient vehicle attitude control device and method that overcomes the cost-related limitations of existing technologies and that may be applied to mass-market vehicles.

The present disclosure is not limited to the above, and other aspects not mentioned above may be understood from the following description, and become more apparent from the example embodiments. Moreover, aspects of the present disclosure may be realized by the means and combinations thereof indicated in the claims.

A vehicle attitude control device according to an aspect of the present disclosure includes a drive unit configured to independently transmit driving force to each of a plurality of wheels of a vehicle, and a control unit configured to recognize a situation (e.g., state) of the vehicle, calculate a driving force (e.g., required) for the situation based on preset (e.g., required) vertical force information corresponding to the situation of the vehicle and vehicle information, and control the drive unit.

The vehicle information may include instantaneous center of rotation information of a front suspension and a rear suspension.

The drive unit may include a front left (FL) drive unit connected to the front suspension and configured to transmit driving force to a front left wheel, a front right (FR) drive unit connected to the front suspension and configured to transmit driving force to a front right wheel, a rear left (RL) drive unit connected to the rear suspension and configured to transmit driving force to a rear left wheel, and a rear right (RR) drive unit connected to the rear suspension and configured to transmit driving force to a rear right wheel.

The control unit may, when an instantaneous center of rotation of the suspension is at a front region, obtain an upward vertical force by applying a forward (FW) direction driving force and obtain a downward vertical force by applying a backward (BW) direction driving force, and when the instantaneous center of rotation of the suspension is at a rear region, obtain an upward vertical force by applying a BW direction driving force and obtain a downward vertical force by applying a FW direction driving force.

Meanwhile, a vehicle attitude control method according to an aspect of the present disclosure includes recognizing a situation (e.g., state) of a vehicle, calculating a driving force (e.g., required) for the situation based on preset (e.g., required) vertical force information corresponding to the situation of the vehicle and vehicle information, and controlling each of a plurality of wheels of the vehicle based on the calculated driving force.

The vehicle information may include instantaneous center of rotation information of a front suspension and a rear suspension.

The controlling may include controlling a front left wheel and a front right wheel connected to the front suspension, and controlling a rear left wheel and a rear right wheel connected to the rear suspension based on the driving force.

Calculating the driving force may include, when an instantaneous center of rotation of the suspension is at a front region, obtaining an upward vertical force by applying a forward (FW) direction driving force and obtaining a downward vertical force by applying a backward (BW) direction driving force, and when the instantaneous center of rotation of the suspension is at a rear region, obtaining an upward vertical force by applying a BW direction driving force and obtaining a downward vertical force by applying a FW direction driving force.

According to the present disclosure, by independently providing driving force to each wheel and (e.g., precisely) controlling the attitude of the vehicle, such as pitch, roll, and heave, stability and ride comfort may be (e.g., simultaneously) improved even in situations of rapid corners, acceleration, and braking.

Additionally, according to the present disclosure, through dynamic attitude control, vehicle body movement may be suppressed and ride comfort may be enhanced, and by using static attitude control, (e.g., necessary) motions may be implemented, thereby providing various business applications and new vehicle contents.

Furthermore, according to the present disclosure, when combined with an in-wheel motor system (IWM), ride comfort degradation and driving performance issues associated with in-wheel motors may be mitigated.

Moreover, according to the present disclosure, the cost-related limitations of existing technologies may be overcome, thereby providing application to mass-market vehicle.

### BRIEF DESCRIPTION OF THE DRAWINGS

The foregoing and other aspects, features, and advantages, as well as the following detailed description of the embodiments, may be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram of a vehicle dynamic (e.g., attitude) control device according to one embodiment of the present disclosure.

FIG. 2 is a flowchart of a vehicle attitude control method according to one embodiment of the present disclosure.

FIG. 3 is a table illustrating vertical force based on a situation of a vehicle according to one embodiment of the present disclosure.

FIGS. 4A, 4B, 4C, and 4D are diagrams illustrating different scenarios of the instantaneous center of rotation of the vehicle suspension according to one embodiment of the present disclosure.

FIG. 5 is a table showing driving force directions for each wheel when the rotation center of the front suspension is at a rear region and the rotation center of the rear suspension is at a front region, according to one embodiment of the present disclosure.

FIG. 6 is a table showing driving force directions for each wheel when the rotation center of the front suspension is at the front region and the rotation center of the rear suspension is at the rear region, according to one embodiment of the present disclosure.

FIG. 7 is a table showing driving force directions for each wheel when the rotation center of the front suspension is at the front region and the rotation center of the rear suspension is also at the front region, according to one embodiment of the present disclosure.

FIG. 8 is a table showing driving force directions for each wheel when the rotation center of the front suspension is at the rear region and the rotation center of the rear suspension is also at the rear region, according to one embodiment of the present disclosure.

### DETAILED DESCRIPTION

The embodiments disclosed in the present specification may be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se may not be considered as having different meanings or functions. In relation to describing the present disclosure, when the detailed description of the relevant known technology is determined to obscure the gist of the present disclosure, the detailed description may be omitted. Furthermore, it may be understood that the appended drawings are intended to help understand embodiments disclosed in the present document and do not limit the technical principles and scope of the present disclosure. It may be understood that the appended drawings include (e.g., all of) the modifications, equivalents or substitutes described by the technical principles and belonging to the technical scope of the present disclosure.

Although the terms first, second, third, and the like may be used herein to describe various elements, components, regions, layers, and/or sections, these elements, components, regions, layers, and/or sections may not be limited by these terms. These terms are used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

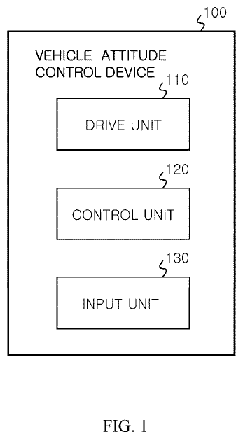

Hereinafter, a vehicle attitude control device and method according to the present disclosure may be described in detail with reference to FIGS. 1 to 8.

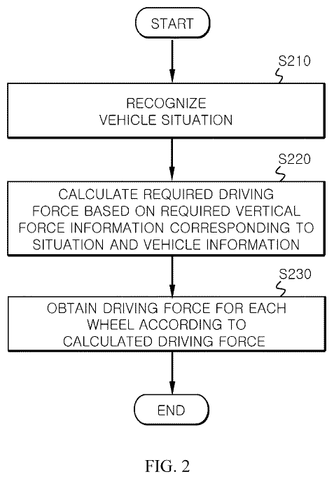

FIG. 1 is a block diagram of a vehicle attitude control device according to one embodiment of the present disclosure, and FIG. 2 is a flowchart of a vehicle attitude control method according to one embodiment of the present disclosure.

Referring to FIG. 1, a vehicle attitude control device (100) according to one embodiment of the present disclosure includes a drive unit (110), a control unit (120), and an input unit (130).

The drive unit (110) independently transmits driving force to each of a plurality of wheels of a vehicle.

If the number of wheels of the vehicle changes, the configuration of sub-drive units included in the drive unit (110), which control each wheel and transmit driving force, is adjusted accordingly. For example, in a four-wheel-drive vehicle according to one embodiment of the present disclosure, the drive unit (110) may include, for (e.g., two) front wheels, a front left (FL) drive unit which transmits driving force to a front left wheel and a front right (FR) drive unit which transmits driving force to a front right wheel, connected to the front suspension, and for (e.g., two) rear wheels, a rear left (RL) drive unit which transmits driving force to a rear left wheel and a rear right (RR) drive unit which transmits driving force to a rear right wheel, connected to the rear suspension.

The control unit (120) recognizes a situation of the vehicle, calculates a driving force (e.g., required) for the situation based on preset (e.g., required) vertical force information corresponding to the situation of the vehicle and vehicle information, and controls the drive unit (110) accordingly.

For example, the control unit (120) may receive information such as steering angle, brake pedal sensor (BPS), and accelerator pedal sensor (APS) information, and information such as yaw rate, wheel speed, longitudinal/lateral acceleration, longitudinal velocity, and wheel slip ratio information, and the like, to recognize the situation of the vehicle (see S210 of FIG. 2). The control unit (120) examines the vertical force (e.g., required) for the corresponding situation and calculates the driving force (e.g., needed) for each wheel to achieve the corresponding vertical force (see S220 of FIG. 2). Here, vehicle information such as center of gravity (COG), wheelbase, total vehicle weight, unsprung mass, and sprung mass information may be further considered to more accurately calculate the (e.g., required) driving force. The control unit (120) then controls the drive unit (110) based on the calculated driving force to ensure that each wheel receives the (e.g., required) driving force (see S230 of FIG. 2).

In detail, the situation of the vehicle includes at least one of a dynamic situation (e.g., state) or a static situation (e.g., state), wherein the dynamic situation of the vehicle includes at least one of right turning, left turning, sudden braking, or sudden acceleration, and the static situation includes at least one of heave, roll, or pitch.

Additionally, the dynamic situation may further include, for example, shaking when going over a speed bump, head toss in which an occupant's head abruptly shakes due to speed bumps or road surface irregularities, bouncing, which refers to up-and-down shaking, coupling motion which occurs when multiple types of shaking combine, LA freeway hop in which the vehicle bounces on uneven highway surfaces, flat road choppy ride, in which slight shaking or discomfort occur on a flat road, bumpy road choppy ride, in which the vehicle (e.g., continuously) shakes when driving on a bumpy road, and situations where the shock of a fall or the feeling of aftershock, impact booming noise, or the like occur while driving.

In addition, the input unit (130) may obtain input information from a user, and in a static situation, the control unit (120) receives the input information, calculates the driving force (e.g., required) for the input information, and controls the drive unit accordingly.

For example, the input unit (130) may include a driver control reception channel to define and implement vehicle attitudes according to a user request, and may be configured to receive input of user-defined modes, default modes, and the like.

The input unit (130) may allow inputs for applying downward vertical force to the rear wheels and upward vertical force to the front wheels to improve accessibility for transportation disadvantaged passengers boarding from the rear of the vehicle or for loading and unloading cargo in a stationary state, inputs for adjusting the vehicle to remain level when stopped on an uneven surface, and inputs for motion linked with in-car content such as 4D movies and games. The control unit (120) calculates the driving force (e.g., required) for each input and controls the drive unit (110) accordingly.

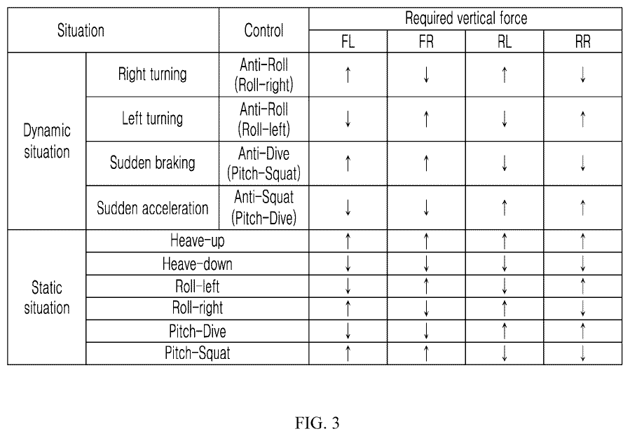

FIG. 3 is a table illustrating vertical force (e.g., required) based on a situation of a vehicle according to one embodiment of the present disclosure. Referring to FIG. 3, the (e.g., necessary) control operations and vertical forces (e.g., required) for dynamic situations of right turning, left turning, sudden braking, and sudden acceleration, and static situations of heave, roll, pitch, dive, and squat, may be identified. In the table, FL is the front left wheel, FR is the front right wheel, RL is the rear left wheel, and RR is the rear right wheel.

Since the direction of the driving force for implementing the (e.g., required) vertical force changes depending on where the instantaneous center of rotation of the vehicle's suspension is located, the vehicle information includes instantaneous center of rotation information for the front suspension and the rear suspension.

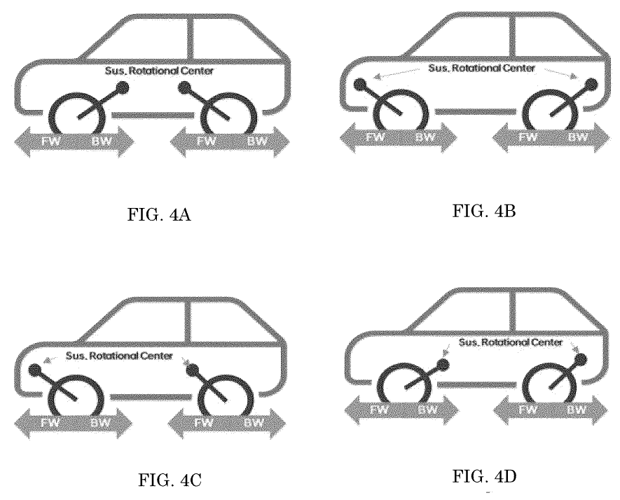

FIGS. 4A, 4B, 4C, and 4D are diagrams illustrating different scenarios of the instantaneous center of rotation of the vehicle suspension according to one embodiment of the present disclosure.

Referring to FIGS. 4A-4D, the instantaneous center of rotation information for a four-wheel vehicle with front suspension and rear suspension may be divided into four scenarios. In FIG. 4A, the instantaneous center of rotation is at a rear region for the front suspension and at a front region for the rear suspension. In FIG. 4B, the instantaneous center of rotation is at the front region for the front suspension and at the rear region for the rear suspension. In FIG. 4C, the instantaneous center of rotation is at the front region for the front suspension and at the front region for the rear suspension. In FIG. 4D, the instantaneous center of rotation is at the rear region for the front suspension and at the rear region for the rear suspension.

In addition, when the instantaneous center of rotation of the suspension is at the front region, upward vertical force is obtained by applying a forward (FW) direction driving force and downward vertical force is obtained by applying a backward (BW) direction driving force. Conversely, when the instantaneous center of rotation of the suspension is at the rear region, upward vertical force is obtained by applying a BW direction driving force and downward vertical force is obtained by applying a FW direction driving force.

For example, in a scenario in which the instantaneous center of rotation of the suspension is at the front region, when a FW direction driving force is applied, the line of action of the driving force generates a torque about the instantaneous center of rotation that lifts the vehicle body, thereby obtaining upward vertical force. Conversely, when BW direction driving force is applied, the line of action of the driving force generates a torque about the instantaneous center of rotation that pulls the vehicle body downward, thereby obtaining downward vertical force.

By contrast, in a scenario in which the instantaneous center of rotation of the suspension is at the rear region, when a FW direction driving force is applied, the line of action of the driving force generates a torque about the instantaneous center of rotation that pulls the vehicle body downward, thereby obtaining downward vertical force, and conversely, when a BW direction driving force is applied, the line of action of the driving force generates a torque about the instantaneous center of rotation that lifts the vehicle body, thereby obtaining upward vertical force.

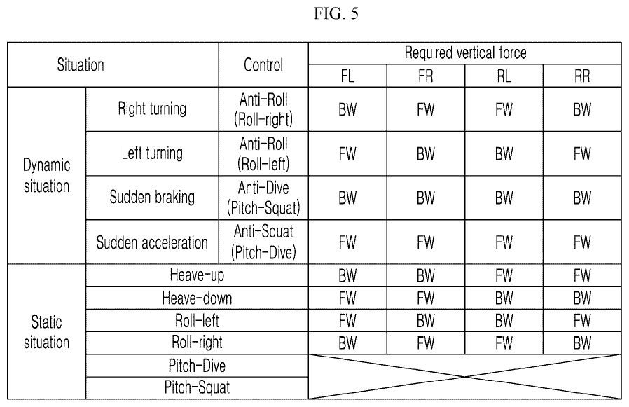

FIGS. 5 to 8 are tables illustrating the driving force directions (e.g., required) for obtaining (e.g., necessary) vertical force in different scenarios of the instantaneous center of rotation of the vehicle suspension according to one embodiment of the present disclosure.

FIG. 5 is a table illustrating the driving force direction (e.g., required) for each wheel when the rotation center of the front suspension is at the rear region and the rotation center of the rear suspension is at the front region. To obtain upward vertical force, the front wheels apply BW direction driving force, and the rear wheels apply FW direction driving force. To obtain downward vertical force, the front wheels apply FW direction driving force, and the rear wheels apply BW direction driving force. At this time, pitch-dive and pitch-squat, which are stationary situations, may not be implemented. To implement, pitch-dive uses (e.g., requires) FW direction driving force on (e.g., all) the wheels, and to implement, pitch-squat uses (e.g., requires) BW direction driving force on (e.g., all) the wheels, and therefore a stationary state may not be implemented.

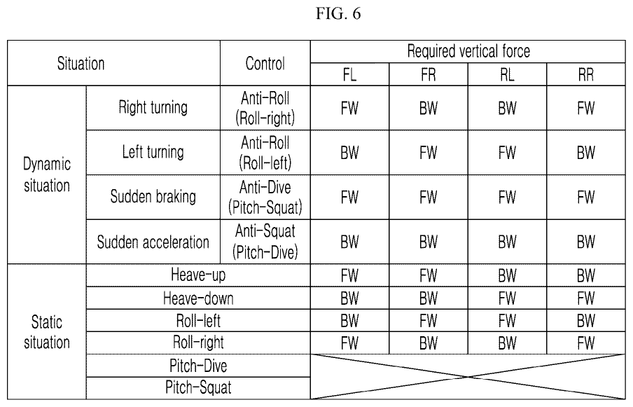

Further, FIG. 6 is a table illustrating the driving force direction (e.g., required) for each wheel when the rotation center of the front suspension is at the front region and the rotation center of the rear suspension is at the rear region. To obtain upward vertical force, the front wheels apply FW direction driving force, and the rear wheels apply BW direction driving force. To obtain downward vertical force, the front wheels apply BW direction driving force, and the rear wheels apply FW direction driving force. At this time, also, pitch-dive and pitch-squat, which are stationary situations, may not be implemented. To implement, pitch-dive uses (e.g., requires) BW direction driving force on (e.g., all) the wheels, and to implement, pitch-squat uses (e.g., requires) FW direction driving force on (e.g., all) the wheels, and therefore a stationary state may not be implemented.

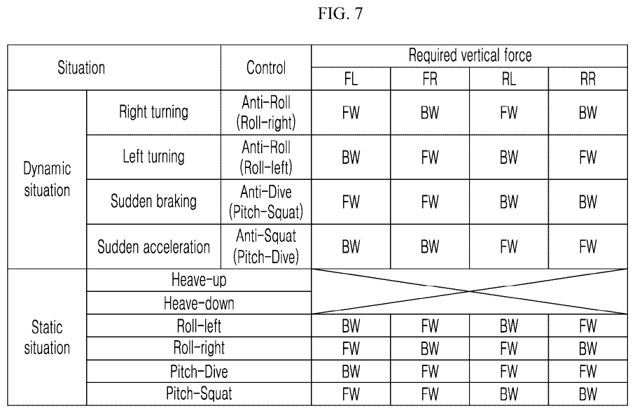

In addition, FIG. 7 is a table illustrating the driving force direction (e.g., required) for each wheel when the rotation center of the front suspension is at the front region and the rotation center of the rear suspension is also at the front region. To obtain upward vertical force, the front wheels apply FW direction driving force, and the rear wheels also apply FW direction driving force. To obtain downward vertical force, the front wheels apply BW direction driving force, and the rear wheels apply FW direction driving force. At this time, heave-up and heave-down, which are stationary situations, may not be implemented. To implement, heave-up uses (e.g., requires) FW direction driving force on (e.g., all) the wheels, and to implement, heave-down uses (e.g., requires) BW direction driving force on (e.g., all) the wheels, and therefore a stationary state may not be implemented.

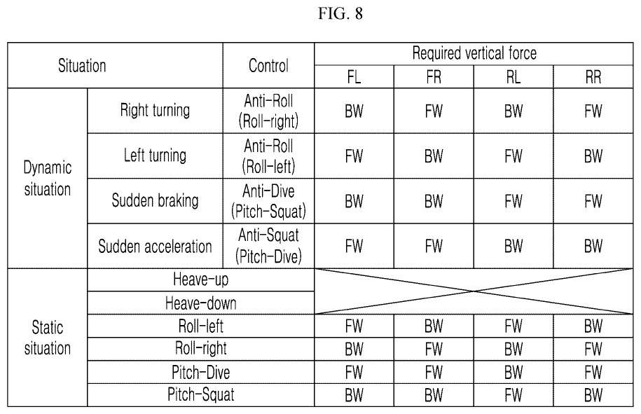

Further, FIG. 8 is a table illustrating the driving force direction (e.g., required) for each wheel when the rotation center of the front suspension is at the rear region and the rotation center of the rear suspension is also at the rear region. To obtain upward vertical force, the front wheels apply BW direction driving force, and the rear wheels also apply BW direction driving force. To obtain downward vertical force, the front wheels apply FW direction driving force, and the rear wheels also apply FW direction driving force. At this time, heave-up and heave-down, which are stationary situations, may not be implemented. To implement, heave-up uses (e.g., requires) BW direction driving force on (e.g., all) the wheels, and to implement, heave-down uses (e.g., requires) FW direction driving force on (e.g., all) the wheels, and therefore a stationary state may not be implemented.

Meanwhile, when the front left wheel and the rear left wheel use (e.g., require) driving forces in different directions, driving force for the front left wheel or the rear left wheel is acquired through braking, and when the front right wheel and the rear right wheel use (e.g., require) driving forces in different directions, driving force for the front right wheel or the rear right wheel is acquired through braking.

For example, when the front left wheel needs to obtain driving force by driving in the FW direction and the rear left wheel needs to obtain driving force by driving in the BW direction, when driving force is applied to the front left wheel, the BW direction driving force for the rear left wheel may be obtained by being replaced with braking force by braking, instead of applying a driving force. This is applicable when the front and rear wheels on the same side, i.e. on the left or right sides, require driving forces in different directions.

In detail, in FIG. 5, for heave-up, the driving force for FL and FR may be replaced with braking, for heave-down, the driving force for RL and RR may be replaced with braking, for roll-left, the driving force for FR and RL may be replaced with braking, and for roll-right, the driving force for FL and RR may be replaced with braking, and in FIG. 6, for heave-up, the driving force for RL and RR may be replaced with braking, for heave-down, the driving force for FL and FR may be replaced with braking, for roll-left, the driving force for FL and RR may be replaced with braking, and for roll-right, the driving force for FR and RL may be replaced with braking.

Through this, the attitude control device and method according to embodiments of the present disclosure may be partially applied even in a two-wheel independent drive system, and may be limited to scenarios where the two front wheels and the two rear wheels use (e.g., require) driving forces in different directions.

Meanwhile, the present disclosure has general applicability to various vehicle systems, including in-wheel motor systems, center-drive electric vehicles (EVs), and internal combustion engine (ICE) vehicles.

As used in the present disclosure, the terms “a/an” and “the” include both singular and plural referents, unless the context states otherwise. Also, it may be understood that any numerical range recited in the present disclosure is intended to include (e.g., all) sub-ranges subsumed therein (unless indicated otherwise) and accordingly, the disclosed numeral ranges include (e.g., every) individual value between the minimum and maximum values of the numeral ranges.

The method according to the present disclosure may be performed in an appropriate order unless a specific order is described or otherwise specified. That is, the present disclosure is not limited to the order in which the steps are recited. The examples described in the present disclosure or the terms indicative thereof (“for example”, “such as”) are to describe the present disclosure in greater detail. Therefore, it may be understood that the scope of the present disclosure is not limited to the example embodiments described above or by the use of such terms. Also, it may be apparent to those skilled in the art that various modifications, combinations, and alternations may be made depending on design conditions and factors within the scope of the appended claims or equivalents thereof.

The present disclosure is thus not limited to the example embodiments described above, and rather the present disclosure is intended to include the claims, and modifications, equivalents, and alternatives falling within the spirit and scope of the appended claims.

1. A vehicle control device for controlling dynamics of a vehicle, the control device comprising:
a drive unit of the vehicle configured to independently transmit driving force to each wheel of a plurality of wheels of a vehicle; and
a control unit configured to recognize a state of the vehicle, calculate a driving force for the state of the vehicle based on preset vertical force information corresponding to the state of the vehicle and vehicle information, and the control unit is configured to control each wheel of the plurality of wheels, via the drive unit, based on the calculated driving force,
wherein the vehicle information includes information indicating an instantaneous center of rotation of vehicle suspensions of the vehicle, the vehicle suspensions including a front suspension and a rear suspension, and
wherein the control unit determines, for each wheel, a direction of the driving force based on a position of the instantaneous center of rotation of the vehicle suspension corresponding to the wheel, to generate a vertical force acting on the vehicle.

2. (canceled)

3. The vehicle control device of claim 1, wherein the drive unit includes:
a front left (FL) drive unit connected to the front suspension and configured to transmit driving force to a front left wheel;
a front right (FR) drive unit connected to the front suspension and configured to transmit driving force to a front right wheel;
a rear left (RL) drive unit connected to the rear suspension and configured to transmit driving force to a rear left wheel; and
a rear right (RR) drive unit connected to the rear suspension and configured to transmit driving force to a rear right wheel.

4. The vehicle control device of claim 3, wherein
the control unit, when an instantaneous center of rotation of the suspension is at a front region, obtains an upward vertical force by applying a forward (FW) direction driving force and obtains a downward vertical force by applying a backward (BW) direction driving force, and
the control unit, when the instantaneous center of rotation of the suspension is at a rear region, obtains an upward vertical force by applying a BW direction driving force and obtains a downward vertical force by applying a FW direction driving force.

5. The vehicle control device of claim 4, wherein
the control unit, when a front left wheel and a rear left wheel use driving forces in different directions, obtains a driving force for the front left wheel or the rear left wheel through braking, and
the control unit, when a front right wheel and a rear right wheel use driving forces in different directions, obtains a driving force for the front right wheel or the rear right wheel through braking.

6. The vehicle control device of claim 1,
wherein the state of the vehicle includes at least one of a dynamic state or a static state,
wherein the dynamic state includes at least one of right turning, left turning, sudden braking, or sudden acceleration, and
wherein the static state includes at least one of heave, roll, or pitch.

7. The vehicle control device of claim 6,
wherein, for the dynamic state, the vehicle information includes vehicle state information,
wherein the vehicle state information includes at least one of a vehicle speed, a longitudinal acceleration, a lateral acceleration, or a wheel slip ratio.

8. The vehicle control device of claim 6,
further including an input unit configured to obtain input information from a user,
wherein, for the static state, the control unit receives the input information, calculates a driving force for the input information, and controls the drive unit.

9. A vehicle control method comprising:
recognizing a state of a vehicle;
calculating a driving force for the state based on preset vertical force information corresponding to the state of the vehicle and vehicle information; and
controlling each wheel of a plurality of wheels of the vehicle based on the calculated driving force,
wherein the vehicle information includes information indicating an instantaneous center of rotation of vehicle suspensions of the vehicle, the vehicle suspensions including a front suspension and a rear suspension, and
wherein the calculating the driving force includes determining, for each wheel, a direction of the driving force based on a position of the instantaneous center of rotation of the vehicle suspension corresponding to the wheel, to generate a vertical force acting on the vehicle.

10. (canceled)

11. The vehicle control method of claim 9, wherein the controlling includes controlling a front left wheel and a front right wheel connected to the front suspension and a rear left wheel and a rear right wheel connected to the rear suspension based on the driving force.

12. The vehicle control method of claim 11, wherein the calculating the driving force includes:
when an instantaneous center of rotation of the suspension is at a front region, obtaining an upward vertical force by applying a forward (FW) direction driving force and obtaining a downward vertical force by applying a backward (BW) direction driving force.

13. The vehicle control method of claim 12, wherein the calculating the driving force includes:
when the instantaneous center of rotation of the suspension is at a rear region, obtaining an upward vertical force by applying a BW direction driving force and obtaining a downward vertical force by applying a FW direction driving force.

14. The vehicle control method of claim 12, wherein the calculating the driving force further includes:
when the front left wheel and the rear left wheel use driving forces in different directions, obtaining a driving force for the front left wheel or the rear left wheel through braking.

15. The vehicle control method of claim 12, wherein the calculating the driving force further includes:
when the front right wheel and the rear right wheel use driving forces in different directions, obtaining a driving force for the front right wheel or the rear right wheel through braking.

16. The vehicle control method of claim 9,
wherein the state of the vehicle includes at least one of a dynamic state or a static state.

17. The vehicle control method of claim 16,
wherein the dynamic state includes at least one of right turning, left turning, sudden braking, or sudden acceleration.

18. The vehicle control method of claim 16
wherein the static state includes at least one of heave, roll, or pitch.

19. The vehicle control method of claim 16,
wherein, for the dynamic state, the vehicle information includes vehicle state information,
wherein the vehicle state information includes at least one of a vehicle speed, a longitudinal acceleration, a lateral acceleration, or a wheel slip ratio.

20. The vehicle control method of claim 16,
further including, prior to the calculating the driving force, obtaining input information from a user,
wherein, for the static state, the calculating the driving force includes receiving the input information and calculating a driving force for the input information.
